(19) United States
(12) Patent Application Publication
(10) Pub. No.: US 2018/0268487 A1
(43) Pub. Date: Sep. 20, 2018

(54) PAYMENT MANAGEMENT SYSTEM

(71) Applicant: U.S. Bancorp, National Association, Minneapolis, MN (US)

(72) Inventors: Bradley O. Matthews, Oak Hill, VA (US); Tory Passons, Minneapolis, MN (US)

(21) Appl. No.: 15/461,261

(22) Filed: Mar. 16, 2017

(51) Int. Cl. G06Q 40/06; G06Q 20/10

(52) U.S. Cl. CPC G06Q 40/06; G06Q 20/10

(57) ABSTRACT

A method includes determining a plurality of payments to be paid from an account over a future period of time. Each of the plurality of payments is associated with at least one due date within the future period of time. The method further includes determining estimated incoming payments to the account for each day of the future period of time. The method further includes determining recommendations for each of the plurality of payments including a specific recommended date within the future period of time on which to pay each of the plurality of payments. The recommended date for each of the plurality of payments is different from the due date of each respective payment. The recommendations are configured to keep the account cash flow positive based on amounts of the plurality of payments and the estimated incoming payments, while satisfying the due date of each of the plurality of payments.

### BACKGROUND

Individuals, businesses, governmental entities, and others often conduct business, communicate, make purchases, perform online banking, pay bills, obtain information, advertise, distribute multi-media content, etc. with each other. For example, a business may transact regularly with utility companies, individual customers, institutional clients, and state, local, and national governments.

Such various entities may utilize different ways of transacting and interacting with each other. Some transactions are conducted using cash, while other transactions occur through bartering goods and/or services. Still other transactions transfer currency using other means, such as a personal check or credit card. The transfer of currency is ubiquitous in modern society, and virtually every individual and entity in today's world transacts with those around them using currency.

### SUMMARY

An illustrative apparatus includes a memory, a processor coupled to the memory, and a first set of instructions stored on the memory that can be executed by the processor. The processor is configured to determine a plurality of payments to be paid from an account over a future period of time. Each of the plurality of payments is associated with at least one due date within the future period of time. The processor is further configured to determine estimated incoming payments to the account for each day of the future period of time. The processor is further configured to determine recommendations for each of the plurality of payments including a specific recommended date within the future period of time on which to pay each of the plurality of payments. The recommended date for each of the plurality of payments is different from the due date of each respective payment. The recommendations are configured to keep the account cash flow positive based on amounts of the plurality of payments and the estimated incoming payments, while satisfying the due date of each of the plurality of payments.

An illustrative method according to a first set of instructions stored on the memory of a computing device, where the method includes determining, by a processor of a computing device, a plurality of payments to be paid from an account over a future period of time. Each of the plurality of payments is associated with at least one due date within the future period of time. The method further includes determining, by the processor, estimated incoming payments to the account for each day of the future period of time. The method further includes determining, by the processor, recommendations for each of the plurality of payments including a specific recommended date within the future period of time on which to pay each of the plurality of payments. The recommended date for each of the plurality of payments is different from the due date of each respective payment. The recommendations are configured to keep the account cash flow positive based on amounts of the plurality of payments and the estimated incoming payments, while satisfying the due date of each of the plurality of payments.

An illustrative system includes a memory, a processor coupled to the memory, and a set of instructions is stored on the memory. The processor is configured to execute the set of instructions to determine a plurality of payments to be paid from an account over a future period of time. Each of the plurality of payments is associated with at least one due date within the future period of time. The processor is further configured to execute the set of instructions to determine estimated incoming payments to the account for each day of the future period of time. The processor is further configured to execute the set of instructions to determine recommendations for each of the plurality of payments including a specific recommended date within the future period of time on which to pay each of the plurality of payments. The recommended date for each of the plurality of payments is different from the due date of each respective payment. The recommendations are configured to keep the account cash flow positive based on amounts of the plurality of payments and the estimated incoming payments, while satisfying the due date of each of the plurality of payments.

### BRIEF DESCRIPTION OF THE DRAWINGS

Illustrative embodiments will hereafter be described with reference to the accompanying drawings.

FIG. 1 is a block diagram illustrating computing devices and a server that may be used in accordance with an illustrative embodiment.

FIG. 2 illustrates a user interface for managing various payments in accordance with an illustrative embodiment.

FIG. 3 illustrates a user interface showing a cash flow analysis graph in accordance with an illustrative embodiment.

FIG. 4 illustrates a user interface showing a current, benchmark, and optimized payment type cost analyses graphs in accordance with an illustrative embodiment.

FIG. 5 illustrates a user interface showing payment type costs in accordance with an illustrative embodiment.

FIG. 6 illustrates a user interface for configuring a payment management system in accordance with an illustrative embodiment.

FIG. 7 is a flow diagram illustrating a method of determining recommendations for payments in a payment management system in accordance with an illustrative embodiment.

FIG. 8 is a flow diagram illustrating a method of determining payment type costs in a cash flow analysis in a payment management system in accordance with an illustrative embodiment.

FIG. 9 is a flow diagram illustrating a method of determining specific recommended dates for payments in a payment management system in accordance with an illustrative embodiment.

### DETAILED DESCRIPTION

Described herein are illustrative embodiments for methods, systems, computer readable mediums, and user interfaces for a payment management system. The payment management includes various features and functionality for maximizing cash flow, cash on hand, minimizing transaction costs, and payment scheduling. The various embodiments described herein address significant problems with a combined accounting and payments domain, particularly in technologies involving specific types of electronic or computerized transactions. For example, certain types of transactions (e.g., automated clearing house (ACH) transactions, credit and/or debit account transactions, check transactions, wire or electronic funds transfer transactions, transactions over the internet such as Paypal™ or Venmo™, bitcoin or other alternate currency, stored value cards, reward accounts or other private currencies) exist completely or partially in an electronic or computerized realm. With such electronic or computerized transactions, problems can arise when transactions have different clearing times (both actual and/or estimated). For example, an ACH transaction may be cleared and funds adequately transferred in one business day. In another example, a check transaction may take nine business days to clear. In another example, a wire transfer may take an estimated one business day for funds to transfer, but may on occasion take an actual two business days to transfer. Accordingly, business and/or individuals that have several ingoing or outgoing transactions may have difficulty tracking their cash flow, cash on hand, credit float, and other aspects of their finance.

Because of the electronic/technological nature of these transactions, it can be impossible for a business or individual to properly track and predict all incoming and outgoing funds. Described herein are technical solutions (i.e., using computerized tracking and planning) for solving the technical problems presented by these electronic and computerized transactions. As just one illustrative example, a business may serve a customer who pays for a large order or service by check. The exact number of days it takes the check to clear and funds to be electronically transferred to the business may be important to the business to pay a bill, such as rent or a utility bill. Accordingly, if several different customers pay by check each month, the business may have even more difficulty tracking when checks clear and funds transfer. It can then become difficult for a business to know whether they are able to pay their bills or not. Using the systems, methods, computer readable mediums, and user interfaces disclosed herein, the business may properly track incoming funds and predict when and how they will be able to make outgoing payments such as bills. Additionally, due to the unpredictable nature of incoming payments, such as how many customers a business might serve in a given month, the embodiments disclosed herein are capable of recommending when to make outgoing recurring payments on different dates of different months depending on cash levels and estimated incoming funds. For example, even if a utility bill is due to a utility company on the 25^{th} of each month, the embodiments may recommend paying the utility bill with a credit card on the 25^{th} of a first month, and may recommend paying the utility bill with an ACH transaction on the 15^{th} of a second month. Such recommendations may be made based on many various factors to maximize cash on hand, cash flow, credit float, etc.

Such technical problems relating to electronic and computerized transactions cannot be adequately solved without a technical solution, such as those described herein. For example, electronic and computerized solutions can monitor actual transactions for closing, estimate future transaction timing and costs, schedule and execute electronic payments of various types. The nature of electronic transactions therefore offers the advantage of electronic tracking and organization of those transactions as disclosed herein.

Another aspect of the technical solutions to the technical problems described in various embodiments herein includes integrating accounting and payment systems. For example, the described embodiments can tell a user, for example, when to pay, how best to pay, and then can execute payments. The embodiments can accomplish the execution of recommended/scheduled payments by integrating a payment tool into an accounting platform itself as opposed to being two separate systems previously only loosely connected. With deployment of such an integrated system, a further technical solution provides for electronic connectivity between the embodiments described herein and an accounting platform, such that the embodiments herein have access to the data of the accounting firm (e.g., accounting elements, accounts receivable and payable, payment elements, payment types, payment costs, etc.). The embodiments disclosed herein can therefore implement electronic payments/transactions to function with regard to accounts payable to execute payments, accounts receivable to manage inbound payments, cash flow analyses that ties the accounts payable and accounts receivable together, and an optimizer that can analyze and recommend payment methods, timing, etc.

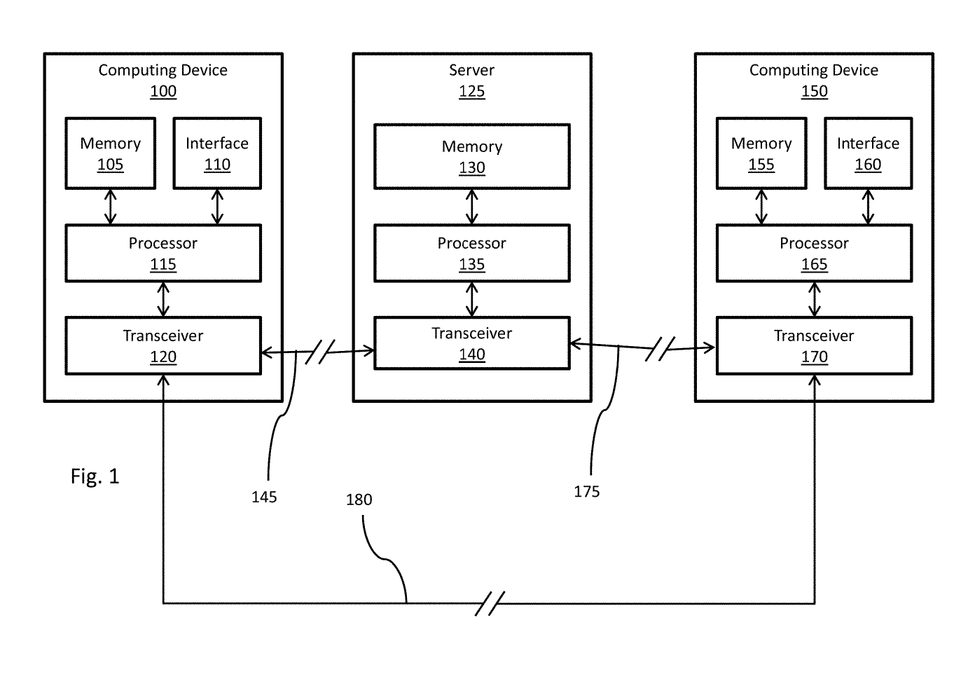

FIG. 1 is a block diagram illustrating computing devices 100 and 150 and a server 125 that may be used in accordance with an illustrative embodiment. In alternative embodiments, fewer, additional, and/or different components may be included in the system. The computing device 100 includes a processor 115 that is coupled to a memory 105. The processor 115 can store and recall data and applications in the memory 105. The processor 115 can execute sets of instructions stored on the memory. In various examples, a set of instructions may be a mobile application (app), other software application, web browser, web application, remotely hosted application, etc. The memory 105 may store any number of software applications, such as billing and/or accounting software programs. The processor 115 may also display objects, applications, data, etc. on an interface 110. An interface may be further referred to herein as a user interface. The processor 115 is also coupled to a transceiver 120. With this configuration, the processor 115, and subsequently the computing device 100, can communicate with other devices, such as the server 125 and the computing device 150 through connections 145 and 180.

The server 125 includes a processor 135 that is coupled to a memory 130. The processor 135 can store and recall data and applications in the memory 130. The processor 135 is also coupled to a transceiver 140. With this configuration, the processor 135, and subsequently the server 125, can communicate with other devices, such as the computing devices 100 and 150 through connections 145 and 175.

The computing device 150 includes a processor 165 that is coupled to a memory 155. The processor 165 can store and recall data and applications in the memory 155. The processor 165 can execute sets of instructions stored on the memory. In one example, a set of instructions may be web browser that displays and/or executes a webpage. In another example, the set of instructions is a software application stored in the memory 155 or the memory 130. The processor 165 may also display objects, applications, data, etc. on an interface 160. The processor 165 is also coupled to a transceiver 170. With this configuration, the processor 165, and subsequently the computing device 150, can communicate with other devices, such as the server 125 and the computing device 100 through the connections 175 and 180.

The devices shown in the illustrative embodiment may be utilized in various ways. For example, the connections 145, 175, and 180 may be varied. The connections 145, 175, and 180 may be a hard wired connection. A hard wired connection may involve connecting the devices through a USB (universal serial bus) port, serial port, parallel port, or other type of wired connection that can facilitate the transfer of data and information between a processor of a device and a second processor of a second device, such as between the computing device 100 and the server 125. In another embodiment, the connections 145, 175, and 180 may be a dock where one device may plug into another device. While plugged into a dock, the client-device may also have its batteries charged or otherwise be serviced. In other embodiments, the connections 145, 175, and 180 may be a wireless connection. Such a connection may take the form of any sort of wireless connection, including but not limited to Bluetooth connectivity, Wi-Fi connectivity, or another wireless protocol. Other possible modes of wireless communication may include near-field communications, such as passive radio-frequency identification (RFID) and active (RFID) technologies. RFID and similar near-field communications may allow the various devices to communicate in short range when they are placed proximate to one another. In an embodiment using near field communication, two devices may have to physically (or very nearly) come into contact, and one or both of the devices may sense various data such as acceleration, position, orientation, velocity, change in velocity, IP address, and other sensor data. The system can then use the various sensor data to confirm a transmission of data over the internet between the two devices. In yet another embodiment, the devices may connect through an internet (or other network) connection. That is, the connections 145, 175, and 180 may represent several different computing devices and network components that allow the various devices to communicate through the internet, either through a hard-wired or wireless connection. The connections 145, 175, and 180 may also be a combination of several modes of connection.

To operate different embodiments of the system or programs disclosed herein, the various devices may communicate in different ways. For example, the computing device 100 may download various software applications, such as an access control app, from the server 125 through the internet. Such software applications may allow the various devices in FIG. 1 to perform some or all of the processes and functions described herein. Additionally, the embodiments disclosed herein are not limited to being performed only on the disclosed devices in FIG. 1. It will be appreciated that many various combinations of computing devices may execute the methods and systems disclosed herein. Examples of such computing devices may include desktop computers, cloud servers, smart phones, personal computers, servers, laptop computers, tablets, blackberries, RFID enabled devices, or any combinations of such devices or similar devices.

In one embodiment, a download of a program to the computing device 100 involves the processor 115 receiving data through the transceiver 120 from the transceiver 140 of the server 125. The processor 115 may store the data in the memory 105. The processor 115 can then execute the program at any time, including at a time specified by the user through the interface 110. In another embodiment, some aspects of a program may not be downloaded to the computing device 100. For example, the program may be an application that accesses additional data or resources located in the server 125. In another example, the program may be an internet-based application, where the program is executed by a web browser and stored almost exclusively in the server 125. In the latter example, only temporary files and/or a web browser may be used on the computing device 100 in order to execute a program, system, application, etc.

In yet another embodiment, once downloaded to the computing device 100, the program may operate in whole or in part without communication with the server 125. In this embodiment, the computing device 100 may access or communicate with the server 125 only when acquiring the program, system, application, etc. through the connection 145. In other embodiments, a constant or intermittent connection 145 may exist between the server 125 and the computing device 100. Where an intermittent connection exists, the computing device 100 may only need to communicate data to or receive data from the server 125 occasionally.

The configuration of the server 125 and the computer devices 100 and 150 is merely one physical system on which the disclosed embodiments may be executed. Other configurations of the devices shown may exist to practice the disclosed embodiments. Further, configurations of additional or fewer devices than the ones shown in FIG. 1 may exist to practice the disclosed embodiments. Additionally, the devices shown in FIG. 1 may be combined to allow for fewer devices or separated where more than the two devices shown exist in a system.

In just one illustrative embodiment, the computing device 100 may be computer that stores and executes the payment management system disclosed herein. The computing device 100 may also store information and applications related to accounting and/or billing that are accessed by the payment management system disclosed herein. In communications with the server 125, the computing device 100 can receive payment information/confirmations, execute payments, receive payments, update various financial account information, etc. For example, the server 125 may be a bank server. The computing device 150 may be a computing device of a business or entity with which the user of the computing device 100 interacts. For example, the computing device 100 may be used to schedule and execute a payment to the computing device 150, either via the server 125 or directly through the connection 180. Additionally, the computing device 100 may receive payments or payment information from the computing device 150 through the server 125 or the connection 180, and the computing device 150 may be a desktop computer. This configuration is merely one physical system on which the disclosed embodiments may be executed. Other configurations of the devices shown may exist to practice the disclosed embodiments. Further, configurations of additional or fewer devices than the ones shown in FIG. 1 may exist to practice the disclosed embodiments. Additionally, the devices shown in FIG. 1 may be combined to allow for fewer devices or may be separated where more than the three devices shown exist in a system.

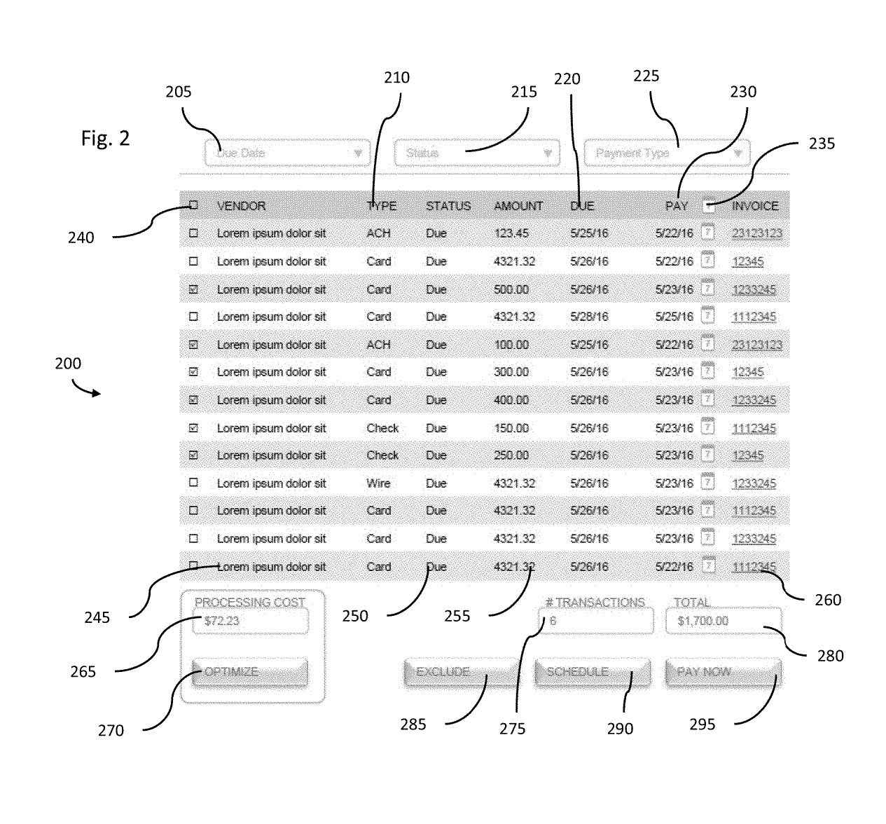

FIG. 2 illustrates a user interface 200 for managing various payments in accordance with an illustrative embodiment. In alternative embodiments, fewer, additional, and/or different components may be included in the user interface. The user interface 200 shows an interface for accounts payable, or payments that are to be paid for a business, individual, etc. In alternative embodiments, accounts receivable, or incoming payments, may be incorporated into the user interface 200 or shown in a similar user interface.

The user interface 200 may be displayed on a visual display such as displays of the computing devices 100 or 150 such that a user can interact with the displays through the interfaces 110 and 160 of the computing devices 100 and 150. In other words, the user interface 200 may be displayed as part of the interfaces 110 and 160, for example.

As will be described further herein, the user interface 200 presents a list of invoices across various statuses (due, paid, scheduled, etc) and across various payment types (check, wire, card, ACH, et.). A user has the ability to, through a user interface such as a mouse, keyboard, touch screen, etc., change dates to be paid, status, or immediately pay invoices. The invoices or payments shown in the user interface 200 can also link directly to a copy of each respective invoice, either as an image of the invoice, or by linking to another software application such as an accounting application.

Specifically the user interface 200 includes sorting selection tools 205, 210, and 215. Using the selection tools 205, 210, and 215, a user can sort, filter, and otherwise display in the user interface 200 the invoices or payments that are of interest to the user. For example, using the selection tool 205, the user can select a date or date range for which invoices are due that should be displayed. Using the selection tool 210, the user can select a particular status or statuses of invoices or payments that should be displayed. With the selection tool 215, the user can select a type or types of payments or invoices that should be displayed. In the user interface 200, the selection tools have been used to display invoices or payments that are due between May 25, 2016 and May 28, 2016, and may be of any payment type.

The user interface 200 includes other ways to identify and sort information. The user interface includes selection boxes 240 that can be used to select a subset of invoices. For example, in the user interface 200, currently six of the invoices displayed are selected using the selection boxes 240. Various functions can be performed with respect to the selection boxes 240. For example, the selected payments may be summarized in dialogs 265, 275, and 280. The processing costs based on the transaction amounts and transaction costs of the six selected invoices/payments are shown in the dialog 265. The processing costs shown in the dialog 265 can change automatically when certain invoices/payments are selected or deselected using the selection boxes 240. In this way, the processing costs are always shown in the dialog 265 for the selected invoices/payments. The total number of transactions selected is shown in the dialog 275. The total dollar amount of the transactions selected is shown in the dialog 280. In an alternative embodiment, the total shown in the dialog 280 may include the processing cost shown in the dialog 265 in the total. Other functions may also be accomplished for selected transactions, payments, invoices, etc. For example, a pay now button 295 may be selected to pay the selected transactions immediately. In one illustrative embodiment, the payment management service is connected to a bank server. In such an embodiment, when the pay now button 295 is selected, a total funds for each of the transactions can be sent as a single file (consolidated payables) regardless of their payment method to the bank server, which can then execute the payments to all vendors using the indicated payment method. The user interface also includes an exclude button 285. The exclude button 285 may be selected to exclude transactions that are indicated by checking the selection boxes in the calculations displayed in the dialogs 265, 275, and 280, such that the dialogs display information related to all transactions that are not selected. In another example, selecting the exclude button 285 may cause the selected payments/transactions to no longer be displayed on the user interface 200. In this way, certain transactions shown on the user interface 200 can be removed from the display and not included in a function executed, such as by selecting a schedule button or the pay now button 295.

If the pay now button 295 is selected to pay some or all of the payments or invoices shown in the user interface 200, the system can pay the invoices/payments selected according to the selection boxes 240. In some embodiments, the system may show the total cost including or in addition to the processing costs for the selected transaction(s), and ask the user to confirm that they would like to execute the transactions in light of the processing costs and/or the total costs.

Other information included on the user interface 200 to identify and sort information includes a vendor name 245, a payment type 210, a payment status 250, a payment amount 255, a due date 220, a scheduled or recommended payment date 230, a calendar link 235, and an invoice number 260. The payment type 210 indicates the payment type used or scheduled for a particular invoice, transaction, or payment. Various payment types may include automated clearing house (ACH) transactions, credit and/or debit account transactions, check transactions, wire or electronic funds transfer transactions, transactions over the internet such as Paypal™ or Venmo™, bitcoin or other alternate currency, stored value cards, reward accounts or other private currencies, cash, or other transaction and payment types. The user interface 200 shows a payment type for each particular transaction. These payment types may be specified automatically or by the user in another application, and imported into the user interface 200. In this way, the user can get an idea for the processing costs associated with the different payment types previously selected in or indicated by another application. In other embodiments, the user interface 200 may be equipped with an option to change a payment type for particular invoices/payments, such as drop down menus, links to open new or inset menus, text input dialogs, or any other method for selecting a transaction type. In other embodiments, the system may generate recommendations for payment types for particular transactions and populate the user interface 200 with its recommendations for payment types.

Such recommendations may be based on cost, due date, available types, etc. For example, recommendations may seek to reduce transaction costs and recommend cheaper transaction types. However, other factors may cause the system to recommend a more expensive transaction type on occasion. For example, if a certain transaction type would not clear or cause funds to be received by a vendor by the due date, a more expensive but faster payment type may be recommended. In another example, the user may not have access to certain payment types. For example, if the user does not have a credit card account linked to the payment management system, the system may not recommend using a credit payment type. In another example, certain vendors may only accept certain payment types, so the system may be confined from offering the cheapest payment type and must instead recommend a more expensive payment type. In another example, the system may include other factors in making a recommended payment type. For example, if cash on hand is low and a payment is due quickly, the system might recommend a credit payment type to take advantage of credit float—that is—satisfy the invoice but defer the cost to the user until a credit statement is due. If the user executes such a credit transaction, the system may automatically update the user interface 200 to include a credit statement transaction that is now due or increased in amount based on the credit transaction.

In another example, the system may also take into account any rewards or incentives related to credit, ACH, bulk discounts, etc. that may be taken advantage of when recommending payment types. For example, if a rebate incentive applies to a credit transaction, the system may have a preference to recommend that payment type if the rebate savings makes up for the difference in cost between the credit transaction and another payment type. In another example, the system may recommend a first payment type for a small total number of transactions or payment total where the first payment type has a low processing cost. However, if the number of transactions or payment total exceeds a threshold such that, for a second payment type, a discount on processing costs would be applied, the system could then recommend the cheaper second payment type.

The payment status 250 provides an indication of the status of various payments/transactions. Here, only due payments are shown. Other payment statuses may include payment in process, payment received, paid, past due, scheduled, executed, etc. The payment amount 255 shows the amount due for a particular payment. Here, that amount does not reflect associated processing costs. However, in other embodiments, the processing costs may be shown in line for each transaction/invoice/payment in addition to the payment amount 255 rather than in aggregate in the dialog 265. In this way, the processing cost of each transaction/invoice/payment could be seen by the user. Therefore, if the user or system changes the recommended or scheduled payment types, the specific amount of how the processing cost for a specific transaction changes based on payment type can also be seen by the user. The user interface 200 may be sorted by any of these categories, and also may be filtered by them to show only certain statuses or amounts of transactions/payments.

The due date 220 shows the date on which a payment is due. As discussed above, the user interface 200 as configured is sorted to show payments due between May 25, 2016 to May 28, 2016. Other ranges can be used, including weekly, monthly, etc. In addition, the user interface could merely display all invoices that are coming due soonest (and past due invoices, if there are any).

The scheduled or recommended payment date 230 shows when a payment is either scheduled to take place or when the system recommends that a particular payment take place. Next to the scheduled or recommended payment date 230, the calendar link 235 is displayed. By selecting the calendar link 235, the user may see an interactive graphical representation of a calendar and be able to manually select a date on which to schedule a particular payment.

The invoice numbers 260 represent unique numbers associated with each invoice or payment in the user interface 200. Related payments (such as a monthly utility bill) may have the same or related invoice numbers 260. Other payments may have unique invoice numbers associated with a bill, invoice, purchase order, or other contract to identify those invoices uniquely. For example, a purchase order to paid may have a particular purchase order (PO) number. The system can link to actual invoice data in an accounting or billing software or application, such that the PO number shown in the user interface 200 matches a PO number from the actual invoice data in the accounting or billing software or application. The invoice numbers 260 can also serve as links to more information about the invoices/payments. For example, if there is a paper contract, bill, or PO associated with an invoice, selecting the link can display an image of that paper contract, bill, or PO. In another example, selecting the link may cause the system to display more information about the invoice (e.g., demographic information about the vendor, payment types accepted by the vendor, known penalties for late payment associated with the vendor, etc.) This additional information may be populated from an accounting or billing software or application that includes actual invoice data. In another example, selecting the link may cause a different software application, such as an accounting or billing software to display more information about an invoice or payment.

The user interface 200 also includes an optimize button 270. By selecting the optimize button 270, the system can determine recommended payment types for each of the payments/transactions shown in the user interface 200. Once determined, the system can display those recommended payment types in the payment type 210 column. Selecting the optimize button 270 can also optimize recommended dates for scheduling each payment shown in the user interface 200 as disclosed herein. Once the recommended dates are determined, they can be displayed in the scheduled or recommended payment date 230 column. In an alternative embodiment, the optimize features that occur (recommending payment type and date for paying) when selecting the optimize button 270 may only be implemented for transactions/payments that are selected according to the selection boxes 210.

The user interface also includes a schedule button 290. The user may select this button to confirm that the invoices displayed on the user interface 200 should be paid on the dates shown in the scheduled or recommended payment date 230 column. Upon selecting the schedule button 290, the user interface 200 may change to indicate that the invoices/payments have been scheduled to be completed on their respective dates. For example, the color of the dates shown in the scheduled or recommended payment date 230 column or the calendar link 235 may change upon selection of the schedule button 290. In another example, selecting the schedule button 290 may schedule payments to be completed only for the payments or invoices selected according to the selection boxes 240. Once a payment is scheduled using the schedule button 290, the system will send that payment, as well as any other scheduled payments, when that date arrives. If there is more than one payment to be executed on a particular date, the consolidated payables method as disclosed herein may be utilized.

In another embodiment, the user interface presents a list of payments due across various statuses with due dates, such as that shown in the user interface 200, and a user can manually or automatically change the due date to accelerate or delay a payment. By paying earlier, certain vendors or other payees may be willing to reduce the amount owed in order to be paid faster. Such a system is disclosed in U.S. patent application Ser. No. 13/546,769, titled “Universal System for Enabling Dynamically Discounted Buyer-Vendor Payments,” which is incorporated herein by reference in its entirety. Therefore, payments owed totals can be reduced. The degree to which payments may be lowered may be known by the system. Thus, the system can automatically calculate how much of a discount is achieved based on the changed due date. The system can reflect that changed amount due in the user interface. In an alternative embodiment, the user may be able to manually adjust the amount due, and the system will calculate the date by which the invoice must be paid to achieve the amount due based on the time paid discount. In some embodiments, the system may inform the user that a particular amount due is not possible. That is, early payment could not result in a particular reduction of a bill or invoice. In various embodiments, optimizing (e.g., by selecting the optimize button 270 of the user interface 200) may take into account these time weighted discounts when recommending payment types and payment schedule dates according to various embodiments disclosed herein.

Accordingly, the system can determine through its recommendations which payments should be accelerated to maximize cash flow and cash on hand. In order to do so, the system determines a plurality of payments to be paid (such as the invoices/payments shown in the user interface 200) from an account over a future period of time. Each of the plurality of payments is associated with at least one due date within the future period of time, as demonstrated in the user interface 200. The system can also determine estimated incoming payments to the account for each day of the future period of time. In this way, the system can understand with this information (along with a starting balance of the account), what funds are or will be available to pay certain invoices, and what the cash balance on those dates will be depending on when certain invoices are paid. The system can then determine recommendations for each of the plurality of payments. As discussed herein, the recommendations can include a specific recommended date within the future period of time on which to pay each of the plurality of payments. The recommendations may further include a recommended payment type. In some cases, the recommended date a payment may be different from the due date of each respective payment. The recommendations are configured to keep the account cash flow positive based on amounts of the plurality of payments and the estimated incoming payments, while still satisfying the due date of each of the plurality of payments.

In some cases, a recurring but related invoice, such as a monthly utility bill, may even be recommended to be paid on different days of successive months. In order to achieve this, the future period of time may encompass days in at least two consecutive months (even if the time displayed in the user interface does not encompass two whole months, though it may). The plurality of payments therefore include a first payment related to a second payment (like the utility bill). The first payment is associated with a first due date in a first month of the two consecutive months and the second payment is associated with a second due date in a second month of the two consecutive months. For example, a utility bill may be due on the 25^{th} of each month. The recommendations can then be determined and include a first specific recommended date for the first payment and a second specific recommended date for the second payment such that the first specific recommended date is a different day of the first month than the second specific recommended date in the second month. These recommendations may also include the payment type recommendations, taking into account possible payment types for each of the plurality of payments and processing costs for each of the possible payment types, as discussed herein. For example, a credit payment type may be recommended to maximize float, such that a payment can be made with credit deferring an impact to the cash flow until a later date when a credit statement is paid.

Similarly, the methods and systems described herein may be leveraged with respect to accounts receivable. For example, if payments are owed to a user, the user may utilize the system to require particular due dates, offer discounts for early payers, and require particular payment types such that a user can maximize their cash flow from payers and/or have enough cash to meet other due dates for payments that the user has to pay. For example, a system may optimize received payments by recommending that all received payments be by ACH or other electronic funds transfer. In such an example, those recommendations may be made because ACH has a relatively low per transaction fee and is executed relatively quickly Accordingly, recommendations for accounts receivable may also be made by the system.

The system may include other features as well, such as the ability for a user or a third party system (e.g., the server 125 of FIG. 1) to determine possible payment types for various payments. For example, vendors may have preferred or required payment types, and payment types that they do not accept at all. Thus, in making recommendations to the user, the system will determine what the possible payment types are for each payment before recommending a payment type. Similarly, the user or another system may set preferred or required payment type for accounts receivable. The user may further manually indicate or select a payment type or subset of the possible payment types that the user would like to use. If the user indicates a specific payment type, that type will be used when the payment is scheduled or executed. If the user selects a subset of available payment types, the system may recommend a payment type from that subset, rather than from all possible payment types.

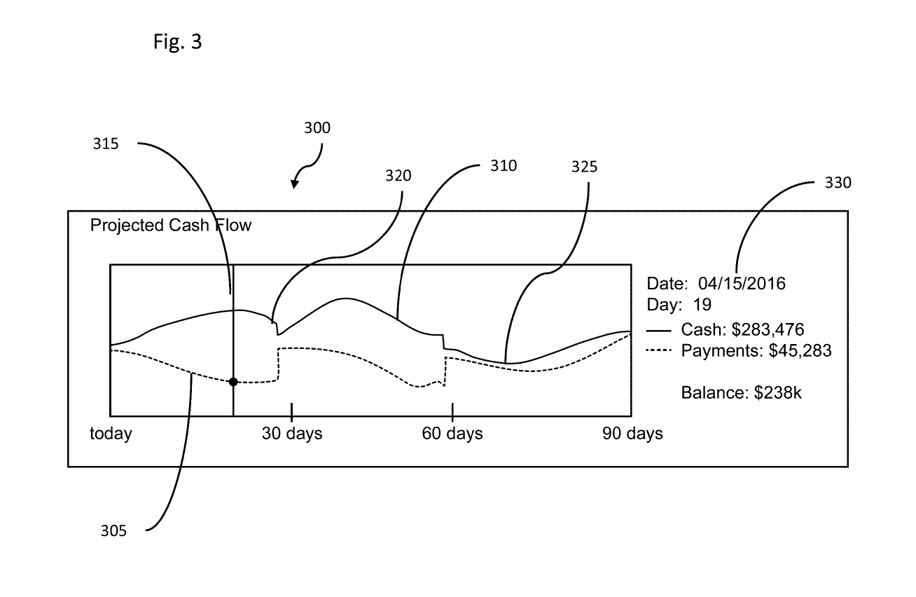

FIG. 3 illustrates a user interface 300 showing a cash flow analysis graph in accordance with an illustrative embodiment. In alternative embodiments, fewer, additional, and/or different components may be included in the user interface. The user interface 300 includes a graph that displays cash in and out over a select time period (e.g. 90 days) to help the user maximize their cash flow. This includes the ability to interrogate the graph to see the actual cash on hand and payments out for any selected day.

The primary usage of the Cash Flow Analysis is to maximize a company's cash flow by moving payments either to ensure positive cash flow or to maximize credit float. The graph user interface 300 includes a cash out line 305 and a cash line 310. Accordingly, the user can see if they are estimated to have enough cash each day to cover payments for that day. In the user interface 300, cash is positive for each of the 90 days shown. To ensure positive cash flow, the user can see days when they are most cash rich at point 315. The user can then manually move payments to that time frame and away from days that are cash poor, such as at point 325. Additionally, as disclosed herein, the system can make recommendations for moving payments to maintain a higher cash level/cash flow on days that would otherwise have a relatively low cash level. Additionally, if the user has a credit card program, they can visually see the cliffs that are caused by relatively large payments occurring within that card cycle coming due on a monthly basis, such as at point 320. The system and/or user can use this to maximize float by moving a payments from days prior to a credit statement payment to a day after the due date of a credit statement, gaining at least a float advantage of, for example, 30+ days.

A legend 330 shows information about the user interface 300. For example, a cursor 315 is placed on the user interface at a particular point along the lines 305 and 310. The legend 330 shows estimated information related to this point in time. In this example, the cursor 315 is at the 19^{th} day of the chart, or Apr. 14, 2016. The available cash at that time is $283,476 and the estimated payments to be made on that day are $45,283. Thus, a balance of cash or cash flow is shown on that day to be approximately $238k.

All of the data, lines, timing, etc. shown in the user interface 300 may be populated from accounts receivable and/or payable system. For example, if payments are managed using the user interface 200 described above, the user interface 300 may be populated according to that data. If the system automatically changes, or the user manually changes, information in the user interface 200, the user interface 300 is automatically updated. For example, if a user moves the date of a payment, the system will reflect that changed payment in the user interface 300. The system may also estimate incoming cash to populate the line 310 and its associated data.

Another advantage of the cash flow analysis shown in the user interface 300 is to move not just payments due that must be paid by a user, but also what payments are due the user by their customers. If a user cannot move a payment they must make to a vendor, the user may be able to accelerate a payment received from a customer to achieve similar ends to moving a payment to a vendor (with respect to cash flow depicted in the user interface 300). This tool shows a user when it would be advisable or necessary to accelerate received payments. Similarly, the systems and methods disclosed can highlight what payments would be ideal to accelerate (closest and significant enough) to increase cash flow on a projected cash poor day. For example, the system may recognize a large payment to be received that would be enough to cover a utility bill, as long as the payment is received two days earlier. Accordingly, a user can ask or require for the payment to be received earlier, potentially offering a percentage discount on the amount due in exchange for accelerated payment from the customer. In this way, the user can get additional cash before the due date of the utility bill to have enough cash to pay it (or have enough cash to pay the utility bill and maintain a desired cash level).

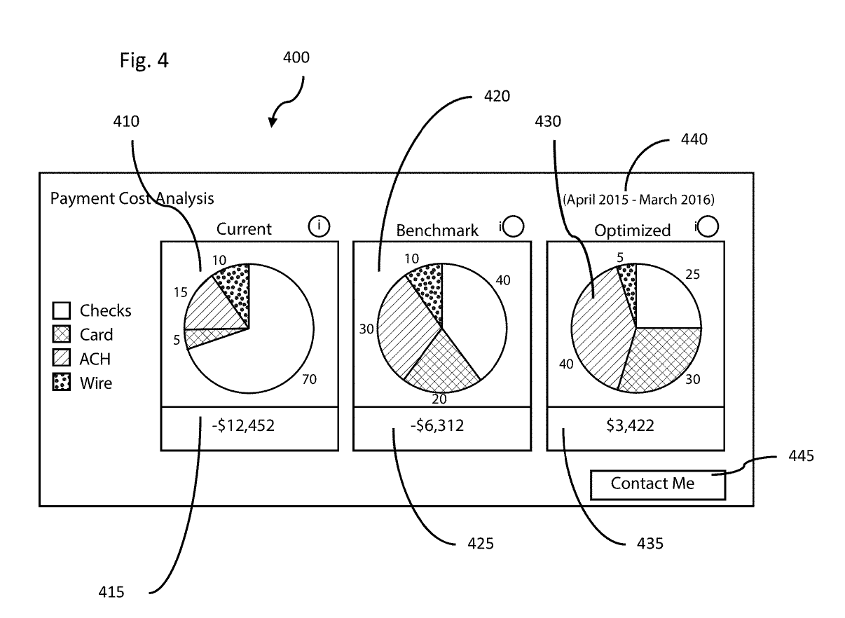

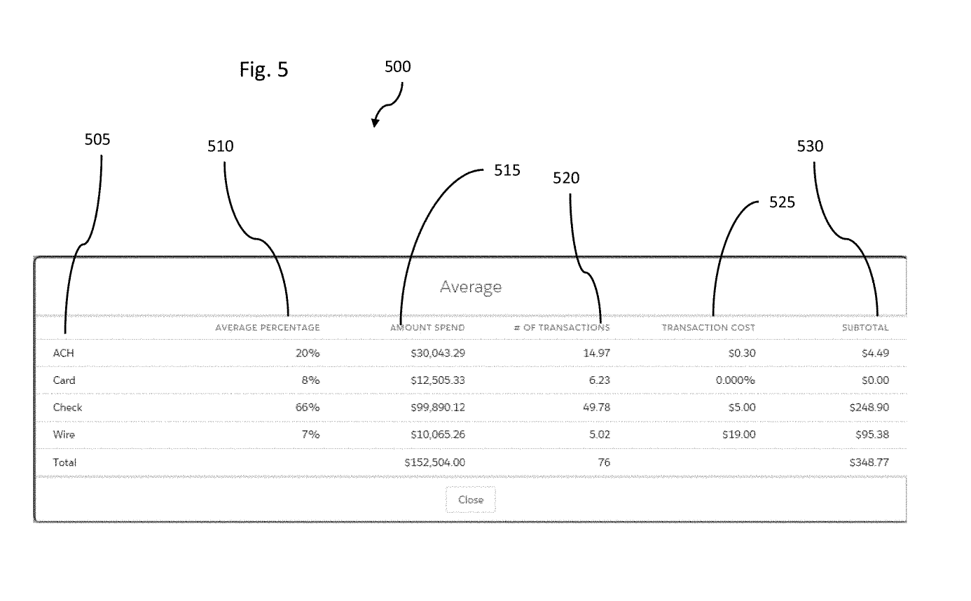

FIG. 4 illustrates a user interface 400 showing a current, benchmark, and optimized payment type cost analyses graphs in accordance with an illustrative embodiment. In alternative embodiments, fewer, additional, and/or different components may be included in the user interface. FIG. 5 illustrates a user interface 500 showing payment type costs in accordance with an illustrative embodiment. In alternative embodiments, fewer, additional, and/or different components may be included in the user interface.

In order to help a user determine the best method of incoming and/or outgoing payments, the system displays a long term (e.g., 12 months) summary of their spend by various payment types, the volume of each, and their associated costs. There are three graphs in the user interface 400 that shows a current payment type cost analysis graph 410 and amount 415 based on current payment data. Accordingly, the graph 410 shows that 70% of payments are by check, 10% are by wire transfer, 15% are by ACH, and 5% are by credit card. A payment processing cost amount 415 indicates a current payment processing cost for a 12 month period of $12,452. If certain types of payments are more costly than others (e.g., ones with high proportions such as checks in this example), those payment types should be sought to be eliminated or reduced.

A benchmark payment type cost analysis graph 420 shows different percentages, such that the total payment processing cost for the 12 month period of an amount 425 is $6,312. The benchmark may be an average by industry, segment, or similar metric. Thus, a user may easily see from the user interface 400 that they have much higher payment processing costs than similarly situated users.

An optimized payment type cost analysis graph 430 shows yet different proportions of transactions such that an amount 435 of processing costs is $3,422. The optimized graph 430 may represent a user in the industry, segment, or similar metric that has the lowest payment processing costs. The optimized graph may also represent a possible payment processing costs possible if the user follows the recommendations of the systems and methods disclosed herein. Thus, a user can see where they are today compared to their peers and an optimal level, and that by moving their payments to different, cheaper, payment types how they can reduce costs, or even drive new revenue. The average and optimized data could also be based on industry studies.

The user interface 500 shows support and additional data for one of the graphs 410, 420, or 430 of the user interface 400. For example, a user may want to see support for each graph and can select a graph to display the supporting numbers as shown in the user interface 500. For example, the user interface 500 shows the payment types 505, percentage 510 of total payments (or total payment amounts) utilizing a payment type, total amounts 515 processed for each payment type, average number of transactions 520 over a period of time (e.g., daily, weekly, bi-weekly, monthly, quarterly, yearly), an average or actual per transaction cost 525, and a subtotal 530 spent on payment processing for each of the payment types.

The user interface 400 also includes a contact me button 445, so that a user may contact a bank or other financial services provider to learn more about reducing their payment processing costs. The user can select the button 445, for example, to have a bank contact them to learn more and have the bank assist them with executing the recommendations. This may be done, for example, by setting up new payment processing options for the user. The bank may also merely assist in implementing changes already recommended by the system. This can be done by reviewing the list of recommendations by vendor and determining with a user which they would like to action. Once selected and switched the vendor may receive notice (through mail or electronic means) that payment types or a default payment type for that vendor will be updated for all future payments.

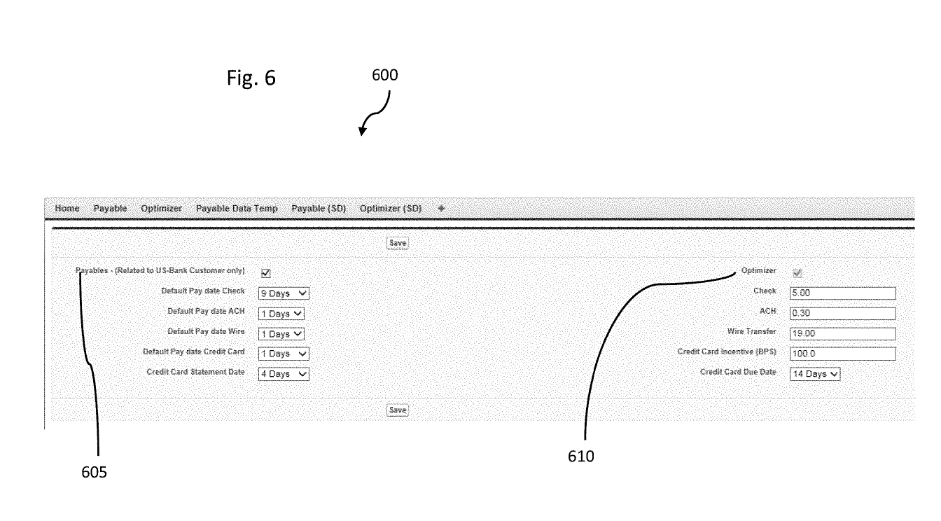

FIG. 6 illustrates a user interface 600 for configuring a payment management system in accordance with an illustrative embodiment. In alternative embodiments, fewer, additional, and/or different components may be included in the user interface. The user interface 600 allows a user to manually adjust characteristics of different payment types, or merely view the varying characteristics of various payment types. The system may have built in defaults based on known processing times and costs for various payment types. If those known times and/or costs change, the system may update them automatically. Additionally, a user may adjust the times or costs manually. The payables 605 information indicates how soon a payment will be initiated by the system before a scheduled payment date. In this way, the system can properly account for processing time for payment of invoices. For example, the payables 605 dictate that a default pay date by check is 9 days, such that a check payment should be initiated 9 days before a scheduled payment date in order to pay on time. In addition to payment processing time by financial institutions, this time could also include time needed by the user's institution to generate a check or payment information. Thus, the dates may be adjusted to account for processes internal to a user. With a one day amount for wire, card, or ACH, the system can initiate those payment types on the same date that the payment types are scheduled. Similarly, the system may use the payables 605 information (or similar information) to estimate how long it takes incoming payments to clear and have cash added to a user's account, which may be used for making recommendations as disclosed herein. The payables 605 also includes how soon before a scheduled date to initiate paying a credit card statement.

Costs 610 for various payment types are also included in the user interface 600. These can be default, or may be manually or automatically adjusted to reflect transaction costs. These may be related to costs specifically charged by financial institutions, or may include costs internal to the user as well. For example, if a user pays a staff person to generate checks and pays a third for the checks, those costs may be incorporated into the costs 610. All of the information in the user interface 600 can be used when determining the recommended payment types and dates according to the methods and systems disclosed herein. The costs 610 also include credit card incentives (a negative cost) that may be incorporated into recommendations for payment types and dates. Additionally, the costs 610 also includes an indication of how long after a credit card statement is received that the statement can be paid. Therefore, the system can determine how much float is possible for various payments when making recommendations.

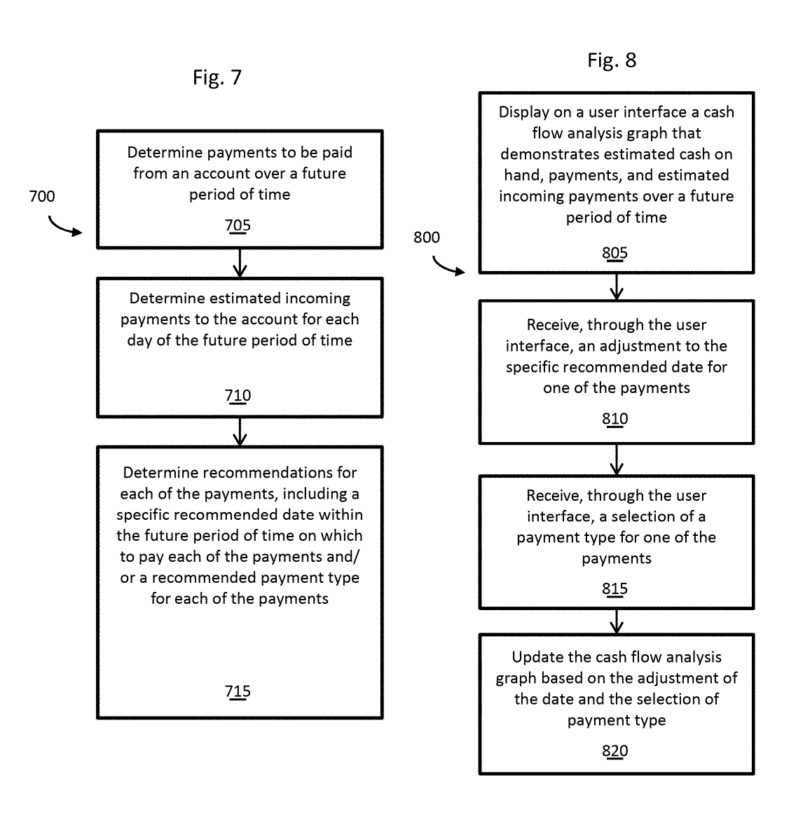

FIG. 7 is a flow diagram illustrating a method 700 of determining recommendations for payments in a payment management system in accordance with an illustrative embodiment. In alternative embodiments, fewer, additional, and/or different operations may be performed. Also, the use of a flow diagram is not meant to be limiting with respect to the order of operations performed. In an operation 705, the system determines a plurality of payments to be paid from an account over a future period of time. Each of the plurality of payments is associated with at least one due date within the future period of time. In an operation 710, the system determines estimated incoming payments to the account for each day of the future period of time.

In an operation 715, the system determines recommendations for each of the plurality of payments comprising a specific recommended date within the future period of time on which to pay each of the plurality of payments. The recommended date for each of the plurality of payments may be different from the due date of each respective payment. The recommendations may be further configured to keep the account cash flow positive based on amounts of the plurality of payments and the estimated incoming payments, while satisfying the due date of each of the plurality of payments. The method 700 may be implemented on a computing device, such as the computing devices 100 or 150 as shown in FIG. 1 and described above. The method 700 may further be implemented utilizing the user interfaces 200, 300, 400, 500, and 600 shown in FIGS. 2-6 and their alternatives described above.

FIG. 8 is a flow diagram illustrating a method 800 of determining payment type costs in a cash flow analysis in a payment management system in accordance with an illustrative embodiment. In alternative embodiments, fewer, additional, and/or different operations may be performed. Also, the use of a flow diagram is not meant to be limiting with respect to the order of operations performed. In an operation 805, the system displays, on a user interface, a cash flow analysis graph that demonstrates estimated cash on hand, a plurality of payments, and estimated incoming payments over a future period of time. In an operation 810, the system receives, through the user interface, an adjustment to a specific recommended date for paying one of the payments.

In an operation 815, the system updates the cash flow analysis graph based on the adjustment. In an operation 820, the system receives, through the user interface, a selection of a payment type the payment. In an operation 825, the system updates the cash flow analysis graph based on a processing cost associated with the selected payment type. The method 800 may be implemented on a computing device, such as the computing devices 100 or 150 as shown in FIG. 1 and described above. The method 800 may further be implemented utilizing the user interfaces 200, 300, 400, 500, and 600 shown in FIGS. 2-6 and their alternatives described above.

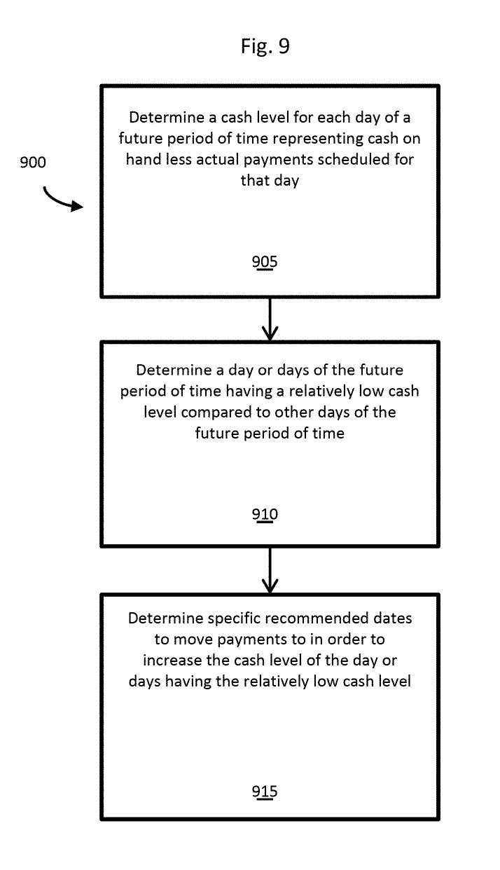

FIG. 9 is a flow diagram illustrating a method 900 of determining specific recommended dates for payments in a payment management system in accordance with an illustrative embodiment. In alternative embodiments, fewer, additional, and/or different operations may be performed. Also, the use of a flow diagram is not meant to be limiting with respect to the order of operations performed. In an operation 905, the system determines a cash level for each day of a future period of time representing cash on hand less actual payments scheduled for that day. In an operation 910, the system determines a day or days of the future period of time having a relatively low cash level compared to other days of the future period of time.

In an operation 915, the system determines, as part of the recommendations, the specific recommended dates to make payments in order to increase the cash level of the day or days having the relatively low cash level. The method 900 may be implemented on a computing device, such as the computing devices 100 or 150 as shown in FIG. 1 and described above. The method 900 may further be implemented utilizing the user interfaces 200, 300, 400, 500, and 600 shown in FIGS. 2-6 and their alternatives described above.

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An apparatus comprising:
a memory;
a processor coupled to the memory; and
a set of instructions stored on the memory and configured to be executed by the processor, wherein the processor is configured to:
determine a plurality of transaction payments to be electronically paid from a business account over a future period of time, wherein each of the plurality of transaction payments is associated with at least one due date within the future period of time;
determine estimated incoming payments to the business account for each day of the future period of time; and
determine recommendations for each of the plurality of transaction payments comprising a specific recommended date within the future period of time on which to pay each of the plurality of transaction payments, wherein the recommended date for each of the plurality of transaction payments is different from the due date of each respective payment;
wherein the recommendations are configured to keep the business account cash flow positive based on amounts of the plurality of transaction payments and the estimated incoming payments;
wherein the recommendations are determined based in part upon the due date and a cost of a payment type.

2. The apparatus of claim 1, wherein:
the future period of time encompasses days in two consecutive months;
the plurality of transaction payments comprise a first payment related to a second payment;
the first payment is associated with a first due date in a first month of the two consecutive months and the second payment is associated with a second due date in a second month of the two consecutive months; and
the recommendations determined by the processor comprise a first specific recommended date for the first payment and a second specific recommended date for the second payment such that the first specific recommended date is a different day of the first month than the second specific recommended date in the second month.

3. The apparatus of claim 1, wherein the specific recommended date for at least one of the plurality of transaction payments is determined based in part upon a discount rate based upon an age of an invoice.

4. The apparatus of claim 1, wherein the processor is further configured to display on a user interface a cash flow analysis graph that demonstrates estimated cash on hand, the plurality of transaction payments, and the estimated incoming payments over the future period of time.

5. The apparatus of claim 4, wherein the processor is further configured to receive, through the user interface, an adjustment to the specific recommended date for one of the plurality of transaction payments.

6. The apparatus of claim 5, wherein the processor is further configured to update the cash flow analysis graph based on the adjustment.

7. The apparatus of claim 4, wherein the processor is further configured to receive, through the user interface, a selection of the payment type for one of the plurality of transaction payments.

8. The apparatus of claim 7, wherein the processer is further configured to update the cash flow analysis graph based on a change to a scheduled day in which one of the plurality of transaction payments is to be made.

9. A method according to a first set of instructions stored on a memory of a computing device, the method comprising:
determining, by a processor of a computing device, a plurality of payments to be paid from an account over a future period of time, wherein each of the plurality of payments is associated with at least one due date within the future period of time;
determining, by the processor, estimated incoming payments to the account for each day of the future period of time; and
determining, by the processor, recommendations for each of the plurality of payments comprising a specific recommended date within the future period of time on which to pay each of the plurality of payments, wherein the recommended date for each of the plurality of payments is different from the due date of each respective payment;
wherein the recommendations are configured to keep the account cash flow positive based on amounts of the plurality of payments and the estimated incoming payments;
wherein the recommendations are determined based in part upon the due date and a cost of a payment type.

10. The method of claim 9, wherein the recommendations further comprise a recommended payment type for each of the plurality of payments, taking into account possible payment types for each of the plurality of payments and processing costs for each of the possible payment types.

11. The method of claim 10, wherein at least one of the recommended payment types comprises a credit payment type.

12. The method of claim 11, wherein for a first payment associated with a first specific recommended date and a first recommended payment type comprising the credit payment type, the first specific recommended date is configured to maximize float, such that the first payment can be made with credit deferring an impact to the cash flow until a later date.

13. The method of claim 10, wherein the recommended payment type for each of the plurality of payments are determined to minimize processing costs associated with the plurality of payments.

14. The method of claim 9, wherein the method further comprises determining, by the processor, at least one recommendation for the payment type for at least one of the incoming payments to minimize processing costs associated with the at least one of the incoming payments.

15. The method of claim 9, wherein the recommendations are further determined by:
determining, by the processor, a cash level for each day of the future period of time representing cash on hand less actual payments scheduled for that day;
determining, by the processor, a day or days of the future period of time having a cash level lower than other days of the future period of time; and
determining, by the processor, as part of the recommendations, the specific recommended dates to make payments in order to increase the cash level of the day or days having the low cash level.

16. A system comprising:
a memory;
a processor coupled to the memory, wherein a set of instructions is stored on the memory and the processor is configured to execute the set of instructions to:
determine a plurality of payments to be paid from an account over a future period of time, wherein each of the plurality of payments is associated with at least one due date within the future period of time;
determine estimated incoming payments to the account for each day of the future period of time; and
determine recommendations for each of the plurality of payments comprising a specific recommended date within the future period of time on which to pay each of the plurality of payments, wherein the recommended date for each of the plurality of payments is different from the due date of each respective payment;
wherein the recommendations are configured keep the account cash flow positive based on amounts of the plurality of transaction payments and the estimated incoming payments;
wherein the recommendations are determined based in part upon the due date and a cost of a payment type.

17. The system of claim 16, wherein the processor is further configured to determine a designation of possible payment types for at least one of the plurality of payments.

18. The system of claim 16, wherein the processor is further configured to receive, through a user interface, a selection of possible payment types for at least one of the plurality of payments.

19. The system of claim 16, wherein the system further comprises a display, and the processer is further configured to output to the display a graphical indication of a current payment type cost analysis, a benchmark payment type cost analysis, and an optimized payment type cost analysis.

20. The system of claim 16, wherein the processor is further configured to receive, through a user interface, a direction to schedule paying at least one of the plurality of payments on a corresponding specific recommended date.
